(19) United States
(12) Patent Application Publication
(10) Pub. No.: US 2021/0144949 A1
(43) Pub. Date: May 20, 2021

(54) IMPROVEMENT IN MILKING SYSTEMS

(71) Applicant: CHAMBER BROS (1999) RETIREMENT AND DEATH BENEFIT SCHEME, Ayrshire (GB)

(72) Inventor: William Shaw MARSHALL, Ayrshire (GB)

(21) Appl. No.: 17/045,942

(22) PCT Filed: Mar. 21, 2019
(86) PCT No.: PCT/GB2019/050807

§ 371 Date: Oct. 7, 2020

(30) Foreign Application Priority Data
Apr. 16, 2018 (GB) 1806199.4

(51) Int. Cl. A01J 7/00

(52) U.S. Cl. CPC A01J 7/00

(57) ABSTRACT

A method of supplying liners (4) for use within teat cups (3) to milking parlours (1) is described. The method involves collecting used liners (4) from a milking parlour (1), delivering those liners (4) to a testing station, performing a test on each of those liners (4), notifying the operator of the milking parlour (1) of a problem with the milking parlour (1) if the test indicates there is such a problem and delivering new liners to the milking parlour (1).

### CROSS-REFERENCE TO RELATED APPLICATIONS

This application is a U.S. National Stage Application under 35 U.S.C. § 371 of International Patent Application No. PCT/GB2019/050807, filed on Mar. 21, 2019, which claims priority to United Kingdom Patent Application No. 1806199.4 filed on Apr. 16, 2018, the disclosure of each of which is hereby incorporated by reference in its entirety.

### FIELD OF INVENTION

The present invention relates to milking parlours that include milking stations which comprise teat cups and liners located inside the teat cups, as used primarily in dairy farming, and in particular, to a process for supplying liners to milking parlours.

### BACKGROUND OF INVENTION

In a typical milking system, often referred to as a parlour, a number of milking stations are arranged so that animals can be milked at each station in parallel.

To milk an animal, a cluster of teat cups are attached to the animal's udder. By varying pressure to the teat cups the udders are massaged and the milk released. A cluster typically comprises four teat cups.

Within each teat cup is a liner, typically made of rubber. The liner is the only part of the milking system that comes into contact with the animal. As a result the inner surface of the liners degrade over time causing discomfort to the animal and are susceptible to transmitting infections between animals and into the milk. Additionally the inner surface of the liner can be affected by incorrect use of chemicals, washing procedure and plant problems e. g. the vacuum system, so producing an increase in the risk of infection, a reduction in udder health, inefficient milk extraction and a decline in milk quality and quantity.

Milk is typically tested monthly by the milk buyers. The milk test is based on the quality of the milk (Bactoscan) and the udder health of the cows (Somatic Cell CountSCC). Higher SCC impairs the quality of the milk and therefore the price the farmer gets for the milk. Once the SCC exceeds a specific level, e. g a count of 400, the farmer will be penalised by receiving a reduced price for his milk. Should the SCC continue to be high the milk buyer may refuse to take milk and the farmer will have to dispose of it.

It is also known that a reduction in udder health can lead to mastitis. This infection can spread across the herd and is costly to treat as the infected animals must be milked separately and the milk disposed of.

A system for identifying problems in milking stations is disclosed in GB 2 425 241 B. In this system, the milking parlour is provided with clusters of teat cups, and each teat cup is provided with a liner. Each liner is tagged so that its position may be recorded within the milking parlour. The used clusters may be exchanged with clean clusters in which the liners have been replaced. After delivery of the used cluster to a testing site, the used liners are examined for deposits on the inner surface of the liner, and each liner provided with a test score according to one of four possible grades. If after the examination of the liner, it is determined that a liner has an unsatisfactory score, the farmer is notified of the unsatisfactory liner and its location within the milking parlour.

A typical UK milking parlour comprises 16 milking stations, which equates to 64 liners as each milking station typically includes 4 liners. A typical US milking parlour comprises 100 milking stations, which equates to 400 liners. A liner has a typical operational life of 6 months.

After a liner has come to the end of its operational life it is disposed of by being sent to a landfill site. This is wasteful, as it is an energy intensive process to manufacture the rubber liners. In addition, when a farmer is supplied with the liners, each liner is supplied in its own plastic bag.

It is an object of the present invention to address one or more failings of prior methods.

### SUMMARY OF INVENTION

According to a first aspect of the present invention, there is provided a method of supplying liners for use within teat cups to milking parlours, the method comprising the steps of:
(a) collecting a plurality of used liners from a milking parlour in a collection receptacle;
(b) delivering the plurality of used liners in the collection receptacle to a testing station;
(c) for each of the plurality of used liners, examining a surface of the liner to provide a condition score of the liner, the condition score indicating whether or not there is a problem in the milking parlour in which the liner has been used, the examination being carried out at the testing station using an electronic scanning device while the liner is whole;
(d) notifying an operator of the milking parlour if a condition score of one or more of the plurality of used liners indicates that there is a problem in the milking parlour; and
(e) delivering a plurality of new liners to the milking parlour, either before or after the delivery of the used liners to the testing station.

For the avoidance of any doubt, the operator may be a farmer or another person associated with the operation of the milking parlour.

The method of the present invention is much simpler than prior methods as the operator does not have to code liners in the milking parlour. In addition, and in contrast to previous methods, the operator is not required to replace whole clusters of his/her milking parlour, if a problem is found. The method also reduces the number of supply receptacles used.

The condition score may be a binary score, indicating pass or fail, wherein the pass score indicates that the liner does not indicate a problem in the milking parlour in which the liner has been used, and wherein the fail score indicates that the liner does indicate a problem in the milking parlour in which the liner has been used.

This provides a quick and easy method of identifying problems in a milking parlour.

The collection receptacle may be a receptacle used for the delivery of the plurality of new liners to the milking parlour.

This means less receptacles are used, thereby minimising waste.

The collection receptacle may be a reversible receptacle and the interior of the receptacle when used for the delivery of the plurality of new liners to the milking parlour is marked with a marking which is visible when the receptacle is reversed, and which indicates to the operator of the milking parlour that the receptacle is suitable for the collection of used liners.

The method may include the further step of cleaning the liners after examination.

This removes any deposits located on the surfaces of the liner, thereby making the rubber of the used liners suitable for recycling. Clean rubber is worth more than dirty rubber.

The method may include the further step of recycling the liners after cleaning.

This means the whole milk producing process is a less wasteful process.

The electronic scanning device may comprise a fiberscope, and an electronic visual display in communication with the fiberscope. In an alternative embodiment, the electronic scanning device may be an electronic X-ray scanning device. In a further alternative embodiment, the electronic scanning device may be an electronic laser scanning device.

During the examination step, an outer surface of the liner may be the surface of the liner examined.

This means that a probe need not be inserted inside a liner, allowing multiple liners to be scanned concurrently.

During the examination step, an inner surface of the liner may be the surface of the liner examined.

The electronic scanning device may comprise a memory for storing information relating to the condition score.

### BRIEF DESCRIPTION OF THE DRAWINGS

Embodiments of the present invention will now be described, by way of example only, with reference to the following drawings, of which:

FIG. 1 shows a milking parlour;

FIG. 2 is a flow chart illustrating a method of supplying liners for use within teat cups to milking parlours according to an embodiment of the present invention; and

FIG. 3 shows a liner being examined in accordance with a step of the method of FIG. 2.

### DETAILED DESCRIPTION OF THE DRAWINGS

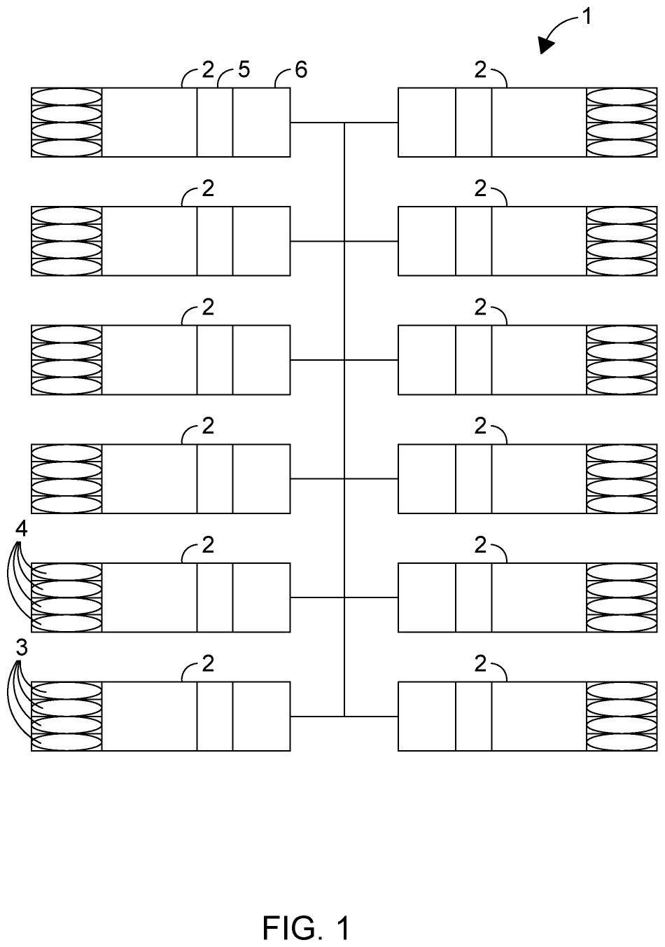

Reference is initially made to FIG. 1 of the drawings, which illustrates a typical milking parlour, generally indicated by reference numeral 1.

The milking parlour 1 comprises twelve production milking stations 2 arranged in parallel. Each station 2 includes four teat cups 3. A liner 4 is located into each teat cup 3. Cleaning/disinfecting systems 5, vacuum systems 6 and the like are fitted at each station 2. Common facilities to all the stations may also be provided. Cows are milked at the milking stations in a known way. While the description will refer to dairy farming where cows are milked, it will be appreciated that the invention could find equal application for milking of any animal.

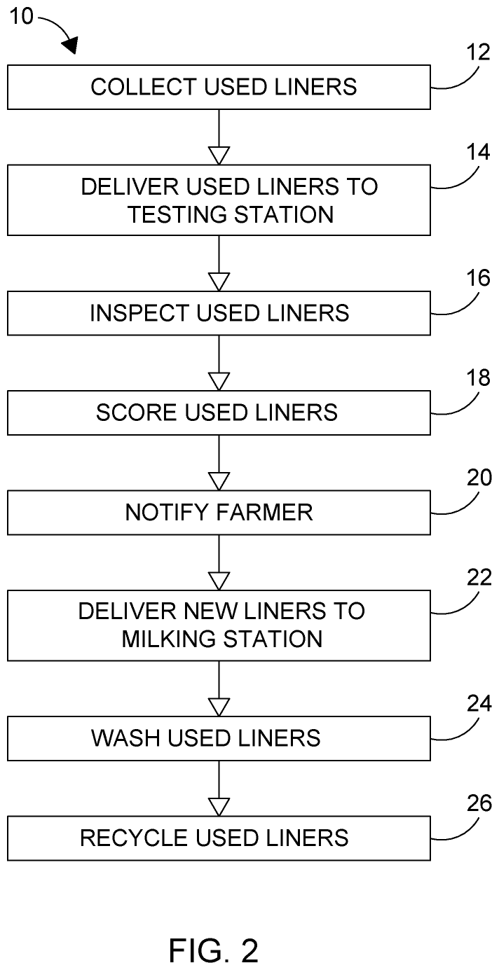

Reference is now made to FIG. 2 of the drawings, which illustrates a flow chart, generally indicated by reference numeral 10, for a method of supplying liners for use within teat cups to milking parlours, according to an embodiment of the present invention.

Initially, liners that have been used during the operation of a milking parlour, such as the one described above, are collected from the parlour in accordance with step 12. These used liners are then delivered to a testing station remote from the milking parlour for inspection, in accordance with step 14.

The used liners are then inspected (examined) to ascertain the amount of deposits present on the inner surface of each liner, in accordance with step 16. The examination step 16 is carried out using an electronic scanning device, and may be carried out using a number of different electronic scanning devices in a number of different ways. Only a few examples are described in this specification.

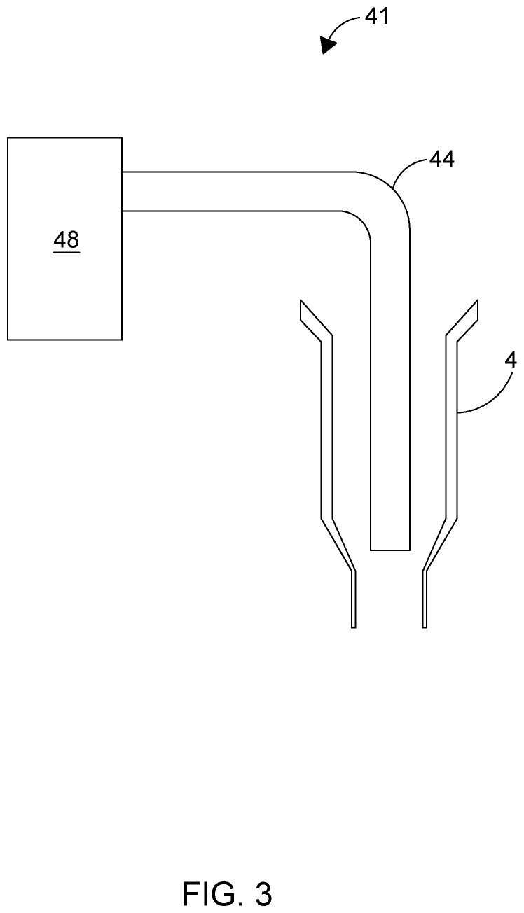

Reference is now made to FIG. 3, where one example of performing the examination step is depicted. In this example, the electronic scanning device 41 comprises a fiberscope 44 in communication with an electronic visual display 48 (shown schematically). The fiberscope 44 may be equipped with a light to increase the quality of the image provided by the electronic visual display 44. A suitable fiberscope 44 is a Series C Videoscope sold by Olympus. Another suitable electronic scanning device is an electronic X-ray scanning device.

During the examination step 16, an outer or an inner surface of the liner 4 may be inspected to determine whether deposits are present on the inner surface of the liner 4. For example, the surface roughness of an outer surface of the liner 4 may be inspected to determine if deposits are present on an inner surface of the liner. Inspecting the outer surface of the liner 4, means that it is not necessary to introduce a probe into each liner, thereby allowing multiple liners to be scanned with one device. Alternatively, and as depicted in FIG. 3, an inner surface of the liner 4 may be inspected using the electronic scanning device 41.

During examination, the surface of the liner is examined for changes in relation to an unused liner or irregularities and other characteristics of the surface. In accordance with step 18 shown in FIG. 2, each individual liner is given a score which is based on categorising the surface.

The examination of the surface may be a simple process, which provides a binary score. A ‘pass’ would be recorded for a liner which is visibly clean, while a ‘fail’ would indicate that there is unacceptable amount of deposits on the inner surface of the liner, and that there is a problem with the milking parlour. This provides a quick procedure for identifying problems in milking parlours.

The electronic scanning device 41 may comprise a memory which is operable to store the results of the scoring step 18.

Once the scoring step 18 has been completed, the operator is notified of the results of the testing in accordance with step 20. Notification may take place by post or by means of electronic communication by communicating the results stored in the memory of the electronic scanning device. The operator may be notified through a simple pass/fail notification, a pass notification indicating that all the liners had a ‘pass’ score, and a fail notification indicating that at least one liner had a ‘fail’ score. Alternatively a fail notification may indicate the number of liners which had a ‘fail’ score. If the results of the examination step show that there is a problem in the milking parlour, i.e. the operator receives a fail notification, then the operator may choose to carry out a more detailed examination of his milking parlour to identify the specific problem.

New liners may then be delivered in accordance with step 22. The flowchart of FIG. 2 shows the delivery of new liners taking place after the delivery of used liners to the testing station. However, the delivery step may of course take place before the delivery of used liners to the testing station.

When used liners are collected from the milking parlour they are collected in a collection receptacle. This collection receptacle may be a receptacle used for the delivery of new liners to the milking parlour. This reduces waste. The collection receptacle may be a reversible receptacle, for example a reversible bin bag. The interior of the receptacle may be used for the delivery of new liners and be provided with a mark which indicates that the receptacle has been reversed. Hence, after delivery of new liners to the milking parlour, the receptacle may be filled with used liners and reversed, thereby indicating that the receptacle should be collected. This reduces the number of receptacles required to carry out the method described herein.

In the embodiment of FIG. 2, after the testing of used liners, the used liners are washed to remove any deposits which have formed on the liners in accordance with step 24. The liners may be washed by using a conventional industrial washing machine. After the liners have been washed, the liners may be recycled in accordance with step 26, for example, by using the liners to form crumb rubber. Recycling the used liners reduces the waste created as a result of the method described herein.

The present invention has at least the following advantages:
1. The method provides quick and easy notification of a potential problem for the operator. The operator is not required to tag each liner, in contrast to previous methods.
2. The operator does not have to record where each liner is located at the milking parlour.
3. Used liners can be simply disposed of in a single receptacle.
4. The method uses a single binary scoring method, which allows the process to be readily automated. No personal judgement of a grade is required.
5. Coded liners are not required.
6. Replacement of the entire cluster is not required.
7. Transport costs of replacement clusters are avoided, and only replacement liners need to be transported.

It will be appreciated by those skilled in the art that various modifications may be made to the invention herein described without departing from the scope thereof, which is defined by the appended claims.

1. A method of supplying liners for use within teat cups to milking parlours, the method comprising the steps of:
(a) collecting a plurality of used liners from a milking parlour in a collection receptacle;
(b) delivering the plurality of used liners in the collection receptacle to a testing station;
(c) for each of the plurality of used liners, examining a surface of the liner to provide a condition score of the liner, the condition score indicating whether or not there is a problem in the milking parlour in which the liner has been used, the examination being carried out at the testing station using an electronic scanning device while the liner is whole;
(d) notifying an operator of the milking parlour if a condition score of one or more of the plurality of used liners indicates that there is a problem in the milking parlour; and
(e) delivering a plurality of new liners to the milking parlour, either before or after the delivery of the used liners to the testing station.

2. The method as claimed in claimed 1, wherein the condition score is a binary score, indicating pass or fail, wherein the pass score indicates that the liner does not indicate a problem in the milking parlour in which the liner has been used, and wherein the fail score indicates that the liner does indicate a problem in the milking parlour in which the liner been used.

3. The method as claimed in claim 1, wherein the collection receptacle is a receptacle used for the delivery of the plurality of new liners to the milking parlour.

4. The method as claimed in claim 3, wherein the collection receptacle is a reversible receptacle and the interior of the receptacle when used for the delivery of the plurality of new liners to the milking parlour is marked with a marking which is visible when the receptacle is reversed, and which indicates to the operator of the milking parlour that the receptacle is suitable for the collection of used liners.

5. The method as claimed in claim 1, including the further step of cleaning the liners after examination.

6. The method as claimed in claim 5, including the further step of recycling the liners after cleaning.

7. The method of claim 1, wherein the electronic scanning device comprises a fiberscope, and an electronic visual display in communication with the fiberscope.

8. The method of claim 1, wherein the electronic scanning device is an electronic X-ray scanning device.

9. The method of claim 1, wherein during the examination step, an outer surface of the liner is the surface of the liner examined.

10. The method of claim 1, wherein during the examination step, an inner surface of the liner is the surface of the liner examined.

11. The method of claim 1, wherein the electronic scanning device comprises a memory for storing information relating to the condition score.
